(19) United States
(12) Patent Application Publication
(10) Pub. No.: US 2012/0256529 A1
(43) Pub. Date: Oct. 11, 2012

(54) METAL HALIDE REFLECTOR LAMP

(75) Inventor: Petrus Wilhelmus Cornelius Verhees, Swalmen (NL)

(73) Assignee: KONINKLIJKE PHILIPS ELECTRONICS N.V., EINDHOVEN (NL)

(21) Appl. No.: 13/518,455

(22) PCT Filed: Dec. 16, 2010
(86) PCT No.: PCT/IB2010/055868

§ 371 Date: Jun. 22, 2012

(30) Foreign Application Priority Data
Dec. 23, 2009 (EP) 09180517.6

(51) Int. Cl. H01J 61/38

(52) U.S. Cl. 313/113

(57) ABSTRACT

The invention relates to a high pressure discharge lamp (100) comprising: a concave (curved inward) reflector body (10) with an axis (11) and a hollow neck portion (12) around the axis having an inner (120) and an outer (121) wall surface, the neck portion being provided with a lamp cap (13) at its end pointing away from the reflector body; the reflector body having a reflective surface (110) on its inwardly curved side and an outer side (111) opposite the inwardly curved side; the inner wall surface of the hollow neck portion being substantially non-reflective; a discharge vessel (14) having at least one leadthrough construction (140). According to the invention the at least one leadthrough construction is at least partly surrounded by the neck portion and in that the neck portion is surrounded by a sleeve (20) being opaque for light, that is being opaque for visible radiation.

### FIELD OF THE INVENTION

The invention is related to a metal halide reflector lamp, in particular such a lamp of very compact size having a light source with a ceramic discharge vessel, also known as ceramic discharge tube or as ceramic burner. Metal halide lamps provided with a ceramic discharge vessel are commonly known, for instance as CDM lamps.

### BACKGROUND OF THE INVENTION

In reflector lamps it is common that the reflector body has a neck shaped portion called neck, which end is provided with a lamp cap including electric contacts suitable to provide electrical connections with contact members of a lamp holder. Commonly the neck shaped portion of the reflector body is made of glass, glass ceramic, quartz glass, quartz or the like and is translucent.

Discharge vessels for CDM lamps are provided with feedthrough constructions for electrically connecting internal electrodes with electric conductors extending from the electric contacts at the lamp cap. Each feedthrough construction comprises a current supply conductor to one of the electrodes, which is fasten to the discharge vessel by means of a sealing glass, also well known under the designation sealing ceramic or melt glass. The sealing glass or melt glass or sealing ceramic provide a gas tight bond between the current supply conductor and the ceramic discharge vessel wall. In many well proven designs of a suitable discharge vessel it has feedthroughs also called leadthroughs, each formed as projecting plug extending from a central body, which central body actually encloses the discharge space. The thus formed projecting plugs form a coldest spot area for those constituents of the discharge vessel filling that are present in excess during stable lamp operation. By means of control of the coldest spot temperature T_{K} the actual vapour pressure of the excess filling constituents is effectively regulated.

### SUMMARY OF THE INVENTION

It is a general felt desire to have reflector lamps as compact as possible. For the described lamps with projecting plugs it is thus desirable to place one of the projecting plugs at least partly inside the neck.

Early reflector designs used reflectors with a Al (aluminum) coating as reflecting surface covering the convave surface of the reflector cup of the reflector body inclusive the internal surface of the neck. However, it is found that the discharge vessel in particular the leadthrough construction heats up due to infra-red (IR) radiation reflected from the Al in the neck. The heating of the leadthrough construction leads to deviations in the color and forms a lifetime risk. This is in particular the case where the discharge vessel is directly placed in the reflector cup, i.e. the reflector cup being a concave shaped reflector body forms the outer bulb also indicated as buba.

A solution against the heating-up of the leadthrough construction is to strongly reduce or even completely preclude the existence of an Al coating in the neck. However this leads to a further problem being the occurrence of spill light through the reflector neck being translucent which is annoying to an observer.

Counteracting the further problem is according to the invention done by providing a sleeve over the outside reflector neck, which sleeve protects against the occurrence of spill light. The reflection of IR radiation is strongly decreased in comparison with a neck coated on its inner wall section with Al reflective coating, because it is at first instance partly absorbed in the translucent material (for instance glass, glass ceramic, quartz glass, quartz or the like) of the neck, next it is partly absorbed in and partly reflected by the sleeve and next the reflected remainder is absorbed once again by the translucent material (for instance glass, glass ceramic, quartz glass, quartz or the like) of the neck. Preferably the sleeve is coated black. In an advantageous embodiment of the lamp of the invention the sleeve is formed of metal.

The sleeve has to cover the part of the translucent neck portion which is not coated by the Al, that is primarily the neck. Besides, the sleeve preferably is in close fit to the translucent neck portion as to be effective in counteracting the problem of light spill. Preferable between the sleeve and translucent neck portion is left not more than a thin air crevice. So, the shape of the sleeve has preferably to be closely similar to the part of the translucent neck portion covered by the sleeve. Limiting factors are formed by the tolerances of both translucent material (for instance glass, glass ceramic, quartz glass, quartz or the like) and sleeve in conjunction with the respective coefficients for thermal expansion. The sleeve may advantageously been provided with a collar as to compensate partly for tolerances. Furthermore, the occurrence or existence of a light crevice can be counteracted or even avoided by means of the collar. Through clipping the sleeve onto the reflector body by means of connecting the collar onto the translucent neck portion with help of small springs it is possible to fix the sleeve to the reflector body in an easy manner. However, it is also acceptable if the sleeve is connected to the reflector body in such way that it still can move around the glass body.

Thickness of the sleeve is primarily dedicated by the processability and cost price of the sleeve material as long as the sleeve is lighttight

Besides being lighttight, the sleeve material has to be easy processable, heat-resistant up to the region of about 400° C. to about 500° C., cheap, shows no discoloring due to oxidation and has good light absorbing properties, that means a small reflection coefficient. For suitable materials the above points to metals or ceramics. Ceramics will probably be more expensive. In some embodiments of the invention described below a sleeve made from aluminum (Al) is used. It may be advantageous to provide the sleeve with a black coating.

It is advantageous to have a blackened inner surface of the sleeve for the prevention of the temperature rising too high inside the neck and the adjoining reflector-space. The thus formed black surface will absorb effectively infrared radiation and thus prevent reflection of IR back to the lamp. A further advantageous improvement is to have blackened also the outer surface of the sleeve, so as to improve the transfer of heat to the space outside the lamp.

### BRIEF DESCRIPTION OF THE DRAWINGS

These and other aspects according the invention are further explained in more detail with reference to the drawings of an embodiment of a lamp according to the invention, in which:

FIG. 1 is a side view of the lamp;

FIG. 2 is a cross-section of the lamp of FIG. 1;

FIG. 3 is a side view of a sleeve being opaque for light used with the lamp of FIG. 1;

FIG. 4 is a cross-section of the sleeve of FIG. 3;

FIG. 5 is an exploded view of the lamp with the sleeve according to FIG. 1; and

FIG. 6 is a perspectiver view of the lamp according to FIG. 5 when completed.

FIG. 7 shows locations of temperature registration points and there designation in the description and Table

### DETAILED DESCRIPTION OF EMBODIMENTS

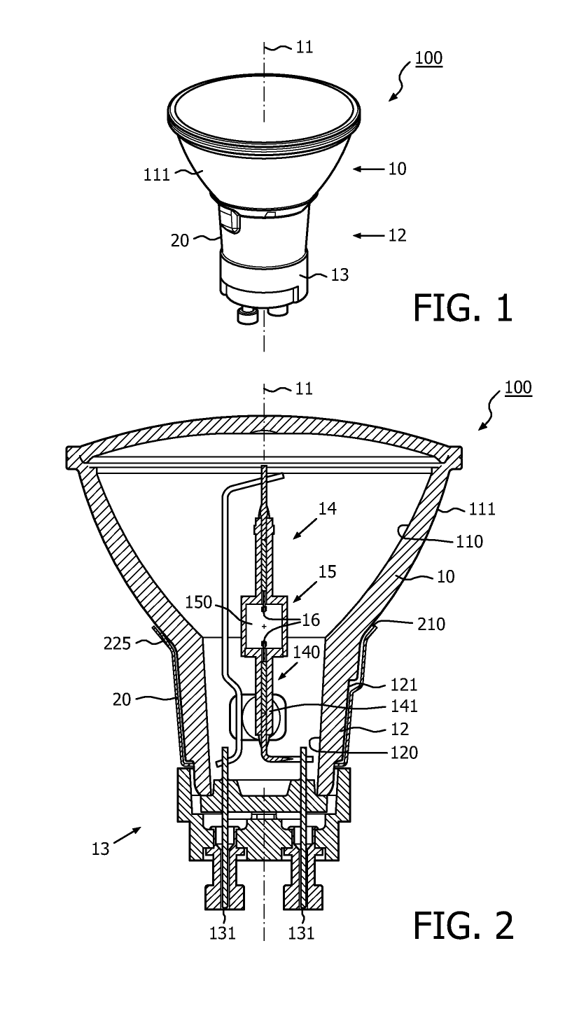

An embodiment of a lamp according to the invention is shown in FIG. 1 in side view and in FIG. 2 in cross-section, wherein a high pressure discharge lamp 100 comprises:

a concave(curved inward) reflector body 10 with an axis 11 and a hollow neck portion 12 around the axis having an inner 120 and an outer 121 wall surface, the neck portion being provided with a lamp cap 13 at its end pointing away from the reflector body; the reflector body having a reflective surface 110 on its inwardly curved side and an outer side 111 opposite the inwardly curved side; the inner wall surface of the hollow neck portion being substantially non-reflective;

a discharge vessel 14 having at least one leadthrough construction 140 and wherein the at least one leadthrough construction is at least partly surrounded by the neck portion and in that the neck portion is surrounded by a sleeve 20 being opaque for light, that is being opaque for visible radiation.

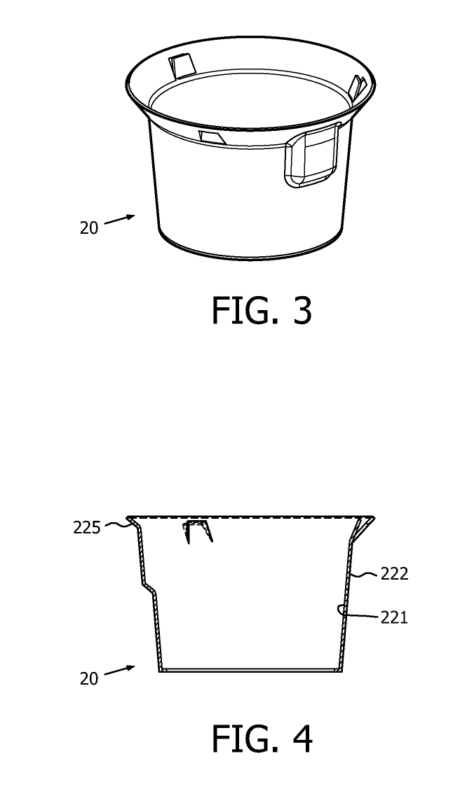

The sleeve 20 is shown in detail FIG. 3 in side view and in FIG. 4 in cross-section.

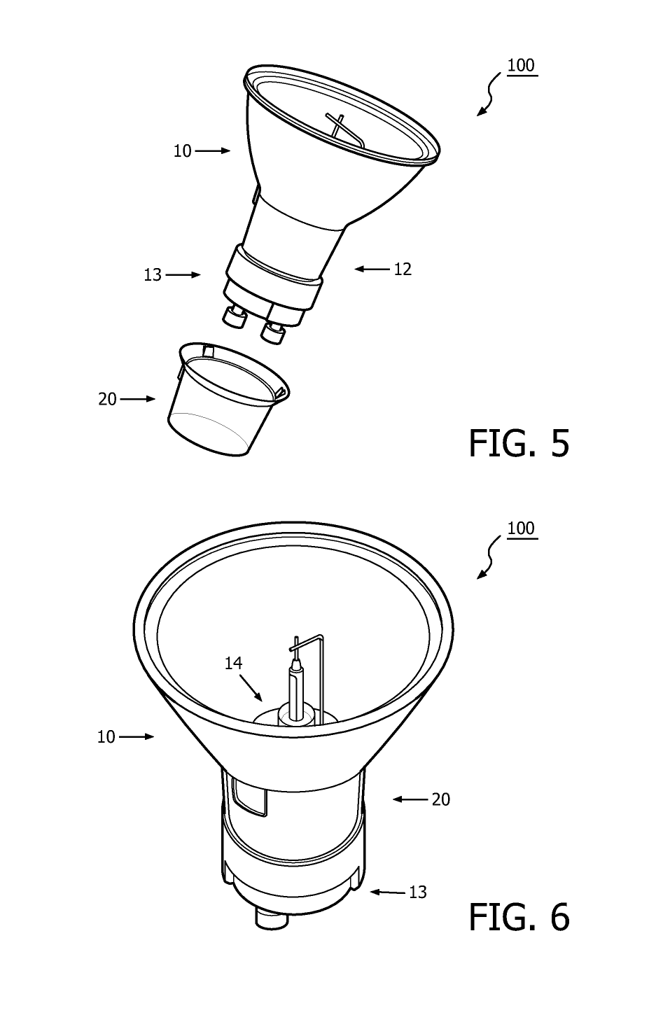

In FIG. 5 an exploded view is shown of the reflector body 10 and the sleeve 20 of the lamp 100 according to FIG. 1. FIG. 6 provides a perspective view of the completed lamp of FIG. 5.

The crevice 210 between neck shaped portion 12 of the reflector body 111 and the surrounding sleeve 20 forms in practical embodiments an airgap.

Throughout the FIGS. 1 to 6 identical parts are indicated with corresponding reference numbers. A summary of the reference numbers as used in the FIGS. 1 to 6 is listed below.

100 lamp according to the invention

10 reflector body

11 axis

110 reflecting surface

111 outer side of reflector body

12 neck shaped portion of the reflector body; neck

120 internal surface of the neck; inner wall surface

121 outside of the reflector neck; outer wall surface

13 lamp cap

131 electric contacts of lamp cap 13

14 discharge vessel

140 feedthrough construction

141 projecting plugs

15 central body

150 discharge space

16 electrodes

20 sleeve

210 crevice

221 inner surface of sleeve 20

222 outer surface of sleeve 20

225 collar of sleeve 20

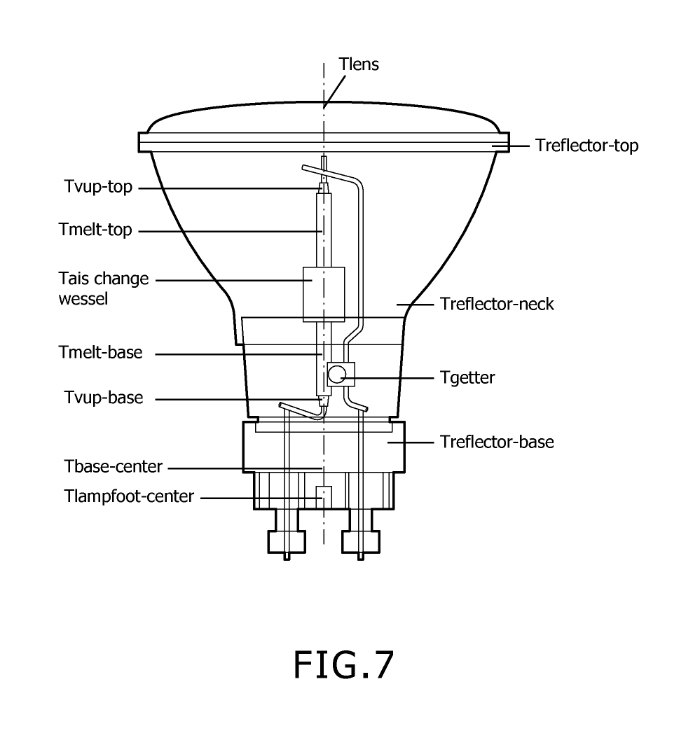

In FIG. 7 the lamp according to FIG. 1 is shown in side-view as a transparent construction. In the figure are indicated the locations of temperature registration points and their designation in a Table.

A number of embodiments of the lamp according to the invention have been compared with a known lamp of similar construction except for the latter lacking a sleeve.

Main data of the lamp embodiments numbered lamp 1 to 11 (alternative numbers c1, c21 to c30) as well as values of temperature at several locations in the lamp during steady operation are listed in the Table.

In the Table are shown the temperature of the surface of the melt glass inside the feedthrough construction of test lamps having projecting plugs. The surface points to the central body of the discharge vessel. The temperature at the surface located in the projecting plug closest to the neck is indicated as Tmelt-base. The temperature at the surface located in the projecting plug opposite hereto is indicated Tmelt-top. The location with the coolest of these temperatures will form the coldest spot in the lamp.

The lamps are operated base-up, that means the light is projected vertically down-wards. All lamps are provided with a reflector body of the same size having a neck of about 20 mm in height.

The width of the airgap formed by the crevice has been varied between 0.05 mm and 1 mm.

For lamp 1 in the Table the reflector is designed thus that the reflective coating extends into the neck over a length of 7 mm. In the other lamps 2 to 11 the coating extends over a length of only 2 mm into the neck, with exception of lamp 8 wherein the neck is free of the reflective coating.

For the used sleeves the emission coefficient is stated by its actual value in the particular case. Sleeves have been coated black at both sides resulting in values for the emission coefficient of IR of at least 0.7 and in most case even 0.9. In an alternative in lamp 11 results are provided of an embodiment with a sleeve of uncoated aluminum having an emission coefficient of 0.2.

With respect to the results of the lamps 1 to 11 the maximum temperature of the wall of the discharge vessel located at the central body 15 of the ceramic discharge lamp is shown as Tdischarge vessel. This temperature should be below about 1500K, preferably below 1440K for achieving acceptable long lamp life times. The surfaces of the melt glass should stay below 920° C., preferably below 820° C. to ascertain lifetimes of the lamp that are regarded acceptable.

| | TABLE | | | | | | | | | | |
|---|---|---|---|---|---|---|---|---|---|---|---|
| | Lamp no | | | | | | | | | | |
| | 1 (c1) | 2 (c21) | 3 (c22) | 4 (c23) | 5 (c24) | 6 (c25) | 7 (c26) | 8 (c27) | 9 (c28) | 10 (c29) | 11 (c30) |
| Discharge vessel | Elite | Elite | Elite | Elite | Elite | Elite | Elite | Elite | Elite | Elite | Elite |
| type and power | 39 W | 39 W | 39 W | 39 W | 39 W | 39 W | 39 W | 39 W | plus | plus | 39 W |
| (W) | | | | | | | | | 20 W | 20 W | |
| Reflector body | Design 1 | Design 2 | Design 2 | Design 2 | Design 2 | Design 2 | Design 2 | Design 2 | Design 2 | Design 2 | Design 1 |
| Length reflecting | 7 | 2 | 2 | 2 | 2 | 2 | 2 | 0 | 2 | 2 | 2 |
| coating on inner | | | | | | | | | | | |
| wall surface of | | | | | | | | | | | |
| neck (mm) | | | | | | | | | | | |
| Sleeve, material | No | Yes | Yes | Yes | No | Yes | Yes | Yes | No | Yes | Yes |
| | — | Al | Al | Al | — | Al | Al | Al | — | Al | Al |
| | | coated | coated | coated | | coated | coated | coated | | coated | uncoated |
| Sleeve | | 0.9 | 0.9 | 0.9 | | 0.7 | 0.9 | 0.9 | | 0.9 | 0.2 |
| Emission | | | | | | | | | | | |
| coefficient | | | | | | | | | | | |
| Crevice width | | 0.1 | 0.05 | 0.5 | | 0.1 | 1 | 0.5 | | 0.5. | 0.5 |
| (mm) | | | | | | | | | | | |
| orientation | Base | Base | Base | Base | Base | Base | Base | Base | Base up | Base up | Base up |
| | up | up | up | up | up | up | up | up | | | |
| Tcentral body | 1467.0 | 1447.0 | 1445.0 | 1450. | 1439.0 | 1448.0 | 1444.0 | 1420.0 | 1278.0 | 1279.0 | 1451.0 |
| (K) | | | | | | | | | | | |
| Tvup-top (K) | 907.2 | 902.2 | 905.7 | 903.6 | 902.2 | 903.1 | 903.4 | 896.8 | 1278.0 | 1279.0 | 1451.0 |
| Tvup-base (K) | 977.8 | 909.7 | 903.9 | 905.7 | 896.5 | 911.6 | 903.1 | 997.9 | 756.9 | 768.2 | 929.4 |
| Tmelt-top (C.) | 759.2 | 754.6 | 756.8 | 753.8 | 754.2 | 756.2 | 756.9 | 746.4 | 607.9 | 610.7 | 758.0 |
| Tmelt-base (C.) | 858.0 | 770.4 | 767.1 | 768.0 | 761.8 | 773.7 | 766.8 | 746.9 | 611.2 | 619.5 | 787.2 |
| Treflector top | 144.0 | 145.1 | 147.0 | 145.0 | 133.0 | 147.1 | 145.4 | 144.0 | 95.0 | 98.1 | 153.5 |
| (C.) | | | | | | | | | | | |
| Treflector-neck | 188.5 | 259.5 | 257.4 | 265.2 | 208.7 | 260.8 | 264.4 | 268.3 | 120.5 | 172.8 | 281.3 |
| (C.) | | | | | | | | | | | |
| Treflector-base | 206.7 | 218.6 | 216.1 | 219.2 | 176.4 | 220.5 | 222.2 | 223.7 | 114.0 | 161.4 | 238.3 |
| (C.) | | | | | | | | | | | |
| Tmax Sleeve (C.) | no | 247.5 | 248.2 | 243.9 | no | 250.3 | 242.6 | 257.7 | no | 168.1 | 183.2 |
| | sleeve | | | | sleeve | | | | sleeve | | |
| Tgetter (C.) | 545.3 | 438.2 | 438.1 | 442.2 | 420.7 | 459.5 | 437.5 | 422.5 | 301.4 | 325.4 | 497.5 |
| Tlens (C.) | 191.4 | 190.5 | 188.5 | 189.3 | 181.6 | 190.5 | 190.9 | 186.2 | 126.1 | 127.3 | 192.8 |
| Tbase center (C.) | 239.9 | 209.2 | 205.6 | 209.9 | 181.1 | 211.9 | 209.9 | 209.6 | 115.6 | 166.4 | 232.5 |
| Tbase max (C.) | 313.5 | 276.1 | 274.8 | 276.8 | 253.3 | 282.7 | 278.2 | 279.3 | 187.1 | 224.5 | 300.4 |
| Tlampfoot center | 165.2 | 167.5 | 168.9 | 168.8 | 140.2 | 170.9 | 169.9 | 172.7 | 94.9 | 133.7 | 182.7 |
| (C.) | | | | | | | | | | | |

From the shown results it is evident that even in a lamp of which the neck is coated with the reflective coating for only about ⅓ of its height, lamp 1 in the Table, the resulting sealing glass temperature as well as the burner temperature still gets higher than is regarded acceptable for achieving aimed at life time expectations. Besides, this lamp having no sleeve, has the drawback of spill light through the part of the neck being uncoated. For lamps 2 to 8 it applies that reducing the length of reflective coating on the neck inner wall surface to at most about 10% of the length of the neck shaped portion reduces both discharge vessel wall temperature Tdischarge vessel as well as the sealing glass temperature

Tmelt-base to values well below the preferred upper limit. A sleeve opaque for light is than sufficient to counteract the problem of spill light without serious affecting the temperature distribution within the reflector body and the discharge vessel.

A different approach shown with lamps 9 and 10 is reducing the wattage of the lamp with maintaining the size of the reflector body. Though lamps are achievable with very satisfactory properties with regard to light generation and life times, a further optimalisation with respect to compactness seems within reach.

Comparing the results of the lamps 3, 2, 4 and 7 shows that the dimension of the crevice (airgap) has only a small impact on the temperature distribution inside the lamp. Using a sleeve with low emission coefficient as is the case in lamp 11 results in a values for sealing glass temperatures Tmelt-top and Tmelt-base well below the preferred level of 820° C. The value of Tdischarge vessel still is just above the preferred threshold, but certainly acceptable for practical lamps. In this respect it is observed that from comparison the results of lamps 4 and 8 it is manifest that with further reducing the length of the reflecting coating on the inner wall surface of the neck the value of Tdischarge vessel can be further lowered significantly.

For practical lamps it turned out that the temperature values as shown in the Table correspond very well to values achieved with camera measurements. Only with respect to values of Tdischarge vessel in case of lamps with a wattage of 20W camera measurements showed values in the range of about 1350K.

1. High pressure discharge lamp (100) comprising:
a concave(curved inward) reflector body (10) with an axis (11) and a hollow neck portion (12) around the axis having an inner (120)and an outer (121) wall surface, the neck portion being provided with a lamp cap (13) at its end pointing away from the reflector body; the reflector body having a reflective surface (110) on its inwardly curved side and an outer side (111) opposite the inwardly curved side; the inner wall surface of the hollow neck portion being substantially non-reflective;
a discharge vessel (14) having at least one leadthrough construction (140) characterized in that the at least one leadthrough construction is at least partly surrounded by the neck portion and in that the neck portion is surrounded by a sleeve(20) being opaque for light, that is being opaque for visible radiation.

2. Lamp according to claim 1, wherein the discharge vessel is a ceramic discharge vessel.

3. Lamp according to claim 1, wherein the lamp is a metal halide lamp and the discharge vessel comprises at least one metal halide.

4. Lamp according to claim 1, wherein the at least one leadthrough construction is formed as an projecting plug (141) extending from a central body (15), which encloses a discharge space (150).

5. Lamp according to claim 1, wherein the reflector body is made of glass or glass ceramic or quartz glass or quartz.

6. Lamp according to claim 1, wherein the reflective surface is formed by a coating of reflective material.

7. Lamp according to claim 1, wherein the sleeve being opaque for light surrounding the neck shaped portion is formed from a metal or from ceramic.

8. Lamp according to claim 1, wherein the sleeve being opaque for light closely fits around the neck shaped portion.

9. Lamp according to claim 1, wherein the sleeve has a dark, preferably black inner surface (221), being the surface directed to the neck shaped portion.

10. Lamp according to claim 1, wherein the sleeve has a dark, preferably black outer surface (222), being the surface directed from the neck shaped portion.

11. Lamp according to claim 1, wherein the sleeve is provided with a collar (225), which extends along the outer side of the reflector body.
